(19) United States
(12) Patent Application Publication
(10) Pub. No.: US 2007/0192135 A1
(43) Pub. Date: Aug. 16, 2007

(54) Signature feature of medical note-taking software

(76) Inventor: James Shoemaker, West Des Moines, IA (US)

Correspondence Address: DAVIS, BROWN, KOEHN, SHORS & ROBERTS, P.C.;THE FINANCIAL CENTER, 666 WALNUT STREET, SUITE 2500, DES MOINES, IA, 50309-3993, US

(21) Appl. No.: 11/655,357

(22) Filed: Jan. 19, 2007

Related U.S. Application Data
(60) Provisional application No. 60/760,909, filed on Jan. 20, 2006.

(51) Int. Cl. G06Q 10/00; H04L 9/00

(52) U.S. Cl. 705/2; 713/180

(57) ABSTRACT

Medical note-taking software is used by healthcare professionals to author notes to be used by the software in generating medical documents. The present invention adds automatic signature functionality. Each healthcare professional user of the software is allowed to enter and save a digital facsimile signature which can, in the discretion of the user, be used by the software application for automatically entering the signature facsimile into medical documents, such as prescriptions, bills, and the like, that are required to be signed. Automatic entry of a signature facsimile into documents requiring signature saves time and steps involved in manually signing the medical document.

This application claims priority to U.S. Patent Application Ser. No. 60/760,909, filed Jan. 20, 2006.

### BACKGROUND OF THE INVENTION

1. Field of the Invention

The invention relates generally to a computer software system for generating medical notes and, more specifically, to a computer software system for generating documents which comprise a patient file which uses an object-based interface and a method for linking objects which includes functionality to permit a user of the software system to create a digital facsimile of the user's signature which may be entered by the software system to selected documents generated by the software system to avoid the delay in printing and manual signing of the document.

2. Background of the Art

Providing medical care to patients involves the generation of large quantities of paper which comprise a patient's medical file. Typically, the patient file is created at the first visit of the patient to a treatment facility, such as a doctor's office, a clinic, a hospital, or the like. The file includes the patient's medical history, treatments, referring physician information, insurance information, current drugs prescribed, test results, diagnoses, X-rays and other image-based information, and notes taken by the healthcare professional to record information regarding the patient conditions, complaints, care instructions and the like. The patient file is updated whenever new information is received, such as upon a subsequent patient visit, the return of laboratory results, correspondence from a consulting physician, and so on. A patient's file will also contain copies of correspondence sent to a physician to which the patient has been referred.

Most healthcare providers still generate notes for patient files by either writing them on forms or in long-hand, or by dictating notes which are then transcribed by non-medical personnel. This process requires significant time by the healthcare provider and/or the cost of the employment of transcribers or a transcription service.

There have been many software systems developed and sold which assist the healthcare provider in generating and maintaining the patient files. One type of system uses voice recognition software to automatically transcribe dictated recording of notes. While such software continues to improve, significant amounts of time must be spent in training the system and, even with much training, the software still makes errors that need to be corrected by human review.

Medical practitioners have highly individualized approaches to their medical practice and hence their preferred form of medical notes and the order and content of those notes is also highly individualized. Medical note generating software that allows the user to customize the software to permit documents generated by a user to included a facsimile of the user's signature upon printing improves the functionality and flexibility of the software for each user.

### SUMMARY OF THE INVENTION

The invention applies to a computer software system for generating medical documents for a patient medical file. The software system includes a user interface with a plurality of components selected by a healthcare provider for the entry of information to be included in the medical documents. The user interface components include metadata objects that relate to medical objects. The healthcare provider selects from the medical objects and the software system generates patient data objects that are added to the medical file of the patient. The software system includes a relational database that is used for storing and retrieving the metadata objects, the medical objects and the patient data objects. Each of the three object components are stored in a table structure wherein a first table stores the object and a second table stores a plurality of properties associated with the object.

Medical documents include medical notes, referral letters, and the like, which require the signature of the medical practitioner. According to the present invention, users of the software system create a signature on a touch-sensitive or similarly functioning screen from which the software generates and stores a digital facsimile of the signature. The user may then use the software to have it automatically enter the signature in the appropriate location on medical documents generated by the software to avoid the delay in requiring that the document first be printed and then the user/medical practitioner located to manually sign the document.

### BRIEF DESCRIPTION OF THE DRAWINGS

FIG. 1 is a dialog box that is used when customizing the software system to generate automatically a digital signature facsimile for entry into applicable medical documents generated by the software system.

FIG. 2 is a dialog box that the medical practitioner uses to enter his or her signature for subsequent use by the software system.

### DETAILED DESCRIPTION OF THE PREFERRED EMBODIMENTS

This specification incorporates herein by this reference U.S. patent application Ser. Nos. 11/040,025, 11/497,756, and 11/602,142.

The invention is a part of an object-oriented software application that produces medical documents using an object-based user interface and item/property data storage. Data storage is set up to store metadata objects, medical objects built on the metadata objects, and patient objects that are the output of the medical objects. A relational database is used to store and retrieve metadata objects, medical objects, and patient data objects. The table structure for the three object components is set up as two tables per object type. The first table stores the object and the second table stores the properties associated with the object.

One function of the software is to generate medical notes, patient referral letters, and the like, that require that they be signed by the medical practitioner. In the past, this has required that the medical document be generated and printed into hard-copy form. Then the medical practitioner must be located so that he or she can manually sign the document. The software has been adapted so that it permits a user of the software to elect to enter into the software system a digital facsimile of his or her signature which the software system uses, at the option of the medical practitioner, to add the facsimile signature to applicable medical documents so that when the documents are printed they already have been signed by the medical practitioner, thereby eliminating the delay in locating and having the medical practitioner manually sign the document.

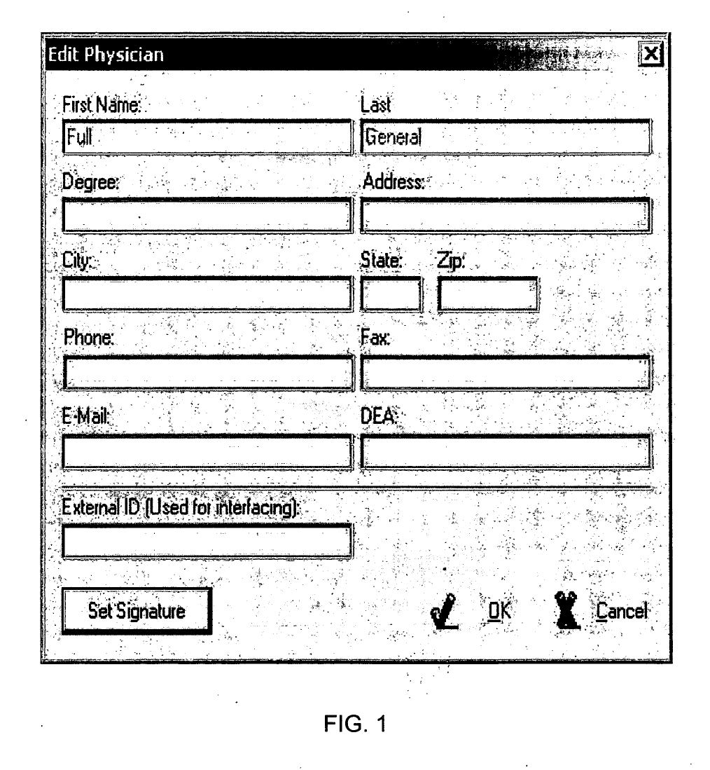

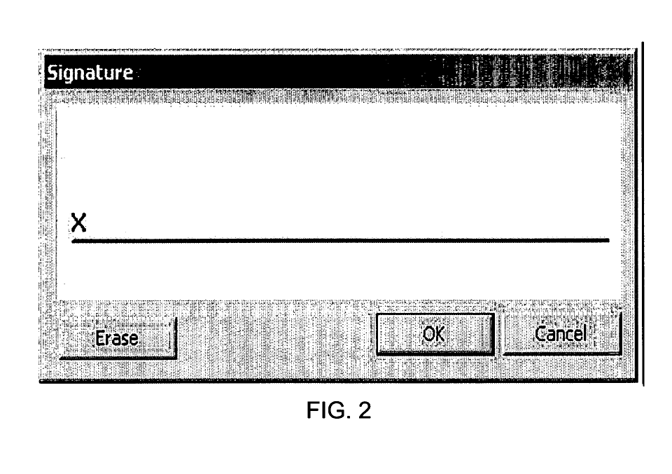

To customize the software system so that the automatic entry of a digital signature facsimile functionality is available for use, a user selects, in a preferred embodiment of the software, an Edit Physician dialog box (FIG. 1). The user uses the First Name and Last areas of the dialog box to cause the dialog box to display the information specific to that user. The user then selects the Set Signature button at the bottom of the dialog box. The software system then displays the Signature dialog box (FIG. 2). The user uses a stylus or similar tool to generate a signature in the screen of the dialog box as if he or she were actually signing a medical document. If the user is satisfied with the signature, the OK button is selected and a digital facsimile of the signature is stored by the software system. If the user wants to change the signature before saving, the Erase button is selected. Pressing Cancel will exit the dialog box of FIG. 2 without saving a digital facsimile of a signature. Once a digital facsimile signature has been saved, the software system will add it to applicable medical documents generated by the associated user.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art who have the disclosure before them will be able to make modifications and variations therein without departing from the scope of the invention.

We claim:

1. A software application for generating medical documents including documents requiring the signature of a medical practitioner, comprising:
(a) a user interface manipulated by a medical practitioner to generate a dialog box;
(b) the dialog box having a space in which the medical practitioner enters a signature which is used by the software application to create a digital facsimile of the signature;
(c) storage of the digital signature facsimile, and
(d) automatic entry of the digital signature facsimile into medical documents requiring the signature of the medical practitioner.
